(19) United States
(12) Patent Application Publication
(10) Pub. No.: US 2016/0322170 A1
(43) Pub. Date: Nov. 3, 2016

(54) TUNGSTEN POWDER, ANODE BODY FOR CAPACITORS, AND ELECTROLYTIC CAPACITOR

(71) Applicant: SHOWA DENKO K.K., Tokyo (JP)

(72) Inventors: Kazumi NAITO, Tokyo (JP); Ryuichi MITSUMOTO, Tokyo (JP)

(73) Assignee: SHOWA DENKO K.K., Tokyo (JP)

(21) Appl. No.: 15/106,057

(22) PCT Filed: Oct. 30, 2014
(86) PCT No.: PCT/JP2014/078952

§ 371 Date: Jun. 17, 2016

(30) Foreign Application Priority Data
Dec. 20, 2013 (JP) 2013-264040

(51) Int. Cl. H01G 9/042; H01G 9/00; H01G 9/15; B22F 1/02; H01G 9/052

(52) U.S. Cl. CPC H01G 9/042; B22F 1/02; H01G 9/0525; H01G 9/15; H01G 9/0029

(57) ABSTRACT

A tungsten powder for an electrolytic capacitor having good leakage current (LC) characteristics, which powder contains molybdenum element only in the particle surface region (first surface region) and having a molybdenum element content of 0.05 to 8 mass %. The tungsten powder preferably has a volume average diameter of the primary particle of 0.1 to 1 μm; the molybdenum element is localized in a region from the particle surface to a depth of 20 nm inside the particle; the tungsten powder contains at least one member selected from tungsten silicide, tungsten containing nitrogen solid solution, tungsten carbide, and tungsten boride only in the particle surface region (second surface region); and the content of phosphorus element is 1 to 500 ppm by mass.

### TECHNICAL FIELD

The present invention relates to a tungsten powder, an anode body using the same, and an electrolytic capacitor using the anode body.

### BACKGROUND ART

With the progress of small-size, high-speed and lightweight electronic devices such as cellular phones and personal computers, the capacitor used for these electronic devices is demanded to have a smaller size, a lighter weight, a larger capacitance and a lower equivalent series resistance (ESR).

As an example of such a capacitor, an electrolytic capacitor has been proposed, which capacitor is produced by anodically oxidizing a sintered body (anode body) obtained by sintering valve-acting metal powder such as tantalum which can be anodized to form a dielectric layer made of the oxide of the metal on the surface of the sintered body.

The electrolytic capacitor using tungsten as a valve-acting metal and employing a sintered body of the tungsten powder as an anode body can attain a larger capacitance compared to the electrolytic capacitor obtained with the same formation voltage by employing an anode body of the same volume using the tantalum powder having the same particle diameter but have a problem of high leakage current (LC).

The present applicant found that the problem of the LC characteristics can be solved by using a tungsten powder comprising a specific amount of tungsten silicide in the particle surface region, and proposed a tungsten powder comprising tungsten silicide in the particle surface region and having a silicon content of 0.05 to 7 mass %; an anode body comprising the sintered body of the tungsten powder; an electrolytic capacitor; and a production method thereof (Patent Document 1; WO 2012/086272; US 2013/277626 A1).

JP 2004-349658 A (Patent Document 2) discloses a capacitor obtained by subjecting tungsten alloy in which molybdenum (Mo) is added in an amount of 0.01 to 10 wt % to chemical formation. The document teaches that use of the Mo-containing alloy can reduce the deterioration in insulation property due to the crystallization of a dielectric layer at the time of anode oxidization, thereby decreasing LC. However, since the anode body of a capacitor is made of a uniform alloy and an oxide of alloy has a low dielectric constant, the capacitor is to have a smaller capacitance.

### PRIOR ART

### Patent Document

Patent Document 1: WO 2012/086272 (US 2013/277626 A1)
Patent Document 2: JP 2004-349658 A

### DISCLOSURE OF INVENTION

### Problems to be Solved by the Invention

An objective of the present invention is to provide a tungsten powder capable of attaining superior LC characteristics while maintaining a large capacitance in an electrolytic capacitor comprising as an anode body a sintered body of tungsten powder used as a valve-acting metal; an anode body using the tungsten powder; and an electrolytic capacitor using the anode body as an electrode.

### Means to Solve the Problem

The present inventors have solved the above-mentioned problem by using a tungsten powder which contains molybdenum element only in the particle surface region and has a molybdenum element content of 0.05 to 8 mass %.

That is, the present invention relates to the tungsten powder, the anode body of the tungsten powder, the electrolytic capacitor, the method for producing the tungsten powder, and the method for producing the anode body for a capacitor as described below.
[1] A tungsten powder, comprising molybdenum element only in the particle surface region (first surface region) and having a molybdenum element content of 0.05 to 8 mass %.
[2] The tungsten powder as described in [1] above, wherein the molybdenum element exists as being molybdenum oxide.
[3] The tungsten powder as described in [2] above, wherein the valence of the molybdenum atom in the molybdenum oxide is six.
[4] The tungsten powder as described in any one of [1] to [3] above, wherein the volume average diameter of the primary particle is 0.1 to 1 μm.
[5] The tungsten powder as described in any one of [1] to [4] above, wherein the first surface region is a region from the particle surface to a depth of 20 nm inside the particle.
[6] The tungsten powder as described in any one of [1] to [5] above, further comprising at least one member selected from tungsten containing nitrogen solid solution, tungsten silicide, tungsten carbide, and tungsten boride only in the particle surface region (second surface region).
[7] The tungsten powder as described in any one of [1] to [6] above, wherein the phosphorus content is 1 to 500 ppm by mass.
[8] The tungsten powder as described in any one of [1] to [7] above, wherein the content of elements other than each element of tungsten, molybdenum, silicon, nitrogen, carbon, boron, phosphorus and oxygen is 0.1 mass % or less.
[9] The tungsten powder as described in any one of [6] to [8] above, wherein the second surface region is a region from the particle surface to a depth of 50 nm inside the particle.
[10] The tungsten powder as described in any one of [1] to [9] above, wherein the tungsten powder is a granulated powder.
[11] An anode body for a capacitor obtained by sintering the tungsten powder described in any one of [1] to [10] above.
[12] An electrolytic capacitor, which is provided with a complex of an anode and a dielectric layer obtained by anode oxidation of the anode body described in [11] above, and a cathode formed on the dielectric layer.
[13] A method for producing the tungsten powder described in any one of [1] to [10] above by mixing a tungsten powder with an aqueous solution of a molybdenum compound so that the molybdenum element content in the tungsten powder falls within a range of 0.05 to 8 mass %, and by allowing the mixture to react through heating under reduced pressure.
[14] The method for producing the tungsten powder as described in [13] above, wherein the heating temperature is from 1,000 to 2,600° C.
[15] The method for producing the anode body for a capacitor, comprising sintering the tungsten powder described in any one of [1] to [10] above.

### Effects of Invention

The tungsten powder of the present invention makes it possible to obtain an anode body for a capacitor capable of producing a capacitor having good leave-to-stand LC characteristics while maintaining a large capacitance compared to the case of using a conventional tungsten powder.

### MODE FOR CARRYING OUT INVENTION

The tungsten powder of the present invention which contains a specific amount of molybdenum element (Mo) in the particle surface region can be produced by conducting the treatment of mixing molybdenum element with a tungsten powder by using a molybdenum solution, heating the treated powder under reduced pressure to make it a granulated powder, and allowing molybdenum element as being molybdenum oxide to localize only in the particle surface region of the tungsten powder. In the case of this method using a molybdenum solution, molybdenum element enters from the surface of the tungsten particles and generally exists in the region within 20 nm inside the tungsten particle from the particle surface. The region in which the molybdenum element exists is the particle surface layer (first surface layer). As described above, the particle surface layer is generally to a depth of 20 nm inside the particle from the particle surface and the size of the region varies depending on the treatment conditions for incorporating molybdenum element. In the present invention, the expression “contain XX element (or compound) only in the first surface region” does not require that 100% of the XX element (or compound) contained in the tungsten powder exists in the first surface region but means that 95% or more of the XX element (or compound) exists in the region.

When a sintered body (anode body for a capacitor) is made by sintering the tungsten powder of the present invention and an electrolytic capacitor element is produced from the anode body, leave-to-stand characteristics of LC values of the capacitor can be improved. With respect to the reason for the improvement of the LC value characteristics by localizing Mo only in the first surface layer of the tungsten powder, it is assumed to be due to the fact that Gibbs free energy is low in oxide generation of Mo. That is, since the Gibbs free energy in oxide generation of Mo is lower than that of tungsten (W), W metal is to deprive Mo oxide of oxygen when the time axis is viewed in a long-term perspective (The journal of the Surface Finishing Society of Japan, Vol. 50, No. 1, pages 2-9 (1999)). That is, it is assumed that even if some of W is not chemically formed and remains in the dielectric layer, W deprives the Mo oxide which exists in a dispersed state on the outermost layer of oxygen to be an oxide, thereby forming a denser dielectric layer. The Mo oxide which has provided oxygen to W remains in the W dielectric layer as being Mo metal, and therefore molybdenum oxide needs to be dispersed in a dielectric layer of tungsten.

A commercially available tungsten powder can be used as a tungsten powder serving as a material of the anode body. A tungsten powder having a smaller particle size is preferable. A tungsten powder having a smaller particle diameter, can be obtained, for example, by pulverizing the tungsten trioxide powder under hydrogen atmosphere using a pulverizing media (The raw material tungsten powder may be referred to as “a coarse powder” in a simple term). As the pulverizing media, a pulverizing media made of the metal carbide such as tungsten carbide and titanium carbide is preferable. In the case of using these metal carbides, fine fragments of the pulverizing media is less likely to be mixed into the powder. Preferred is a pulverizing media made of tungsten carbide.

The tungsten powder having a smaller particle diameter can also be obtained by reducing the tungsten acid and halogenated tungsten using a reducing agent such as hydrogen and sodium and appropriately selecting the reducing conditions. Also, the tungsten powder can be obtained by reducing the tungsten-containing mineral directly or through several steps and by selecting the reducing conditions.

The molybdenum solution used in the present invention is a solution such as an aqueous solution of a compound containing molybdenum element. After mixing a tungsten powder with a compound containing molybdenum element, the mixed powder is decomposed at a temperature of the upper limit for granulating a tungsten powder (about 2,600° C.) or lower to thereby allow the compound containing molybdenum element to be incorporated in the surface layer of a tungsten powder as being molybdenum oxide.

An example of the molybdenum solution is an aqueous solution of ammonium molybdate. In the case of concurrently incorporating phosphorus element (P) in a tungsten powder, phosphomolybdic acid can be used. In the case of using phosphomolybdic acid, an ethanol solution and an ether solution can be used, and if a compound containing molybdenum element is soluble, an organic solvent such as acetylacetone can be used as a solvent.

It is possible to localize molybdenum oxide in the first particle surface layer of a tungsten powder by using a molybdenum oxide powder (MoO₃), but it is preferable to use an aqueous solution from the viewpoint of uniform dispersion.

It is possible to use a solution of tetramethylammonium salt containing Mo₆O₁₉²⁻ (hexamolybdate ion), but it is undesirable because there are problems in ease in handling and the cost for waste liquid treatment.

The concentration of an aqueous solution of ammonium molybdate can be adjusted if the solution has a concentration lower than a saturated solution. However, it is desirable to dilute the concentration as appropriate before mixing it with a tungsten powder from the viewpoint of localizing molybdenum oxide uniformly only in the first surface layer of the tungsten powder in the above-mentioned amount.

Most of the molybdenum element in the tungsten powder exists as being an oxide. It is known that there are crystallized forms of molybdenum oxide such as MoO, Mo₂O₃, MoO₂, Mo₂O₅ and MoO₃. The valence of molybdenum element in the tungsten powder may be either from 2 to 6. When molybdenum oxide in a tungsten powder is subjected to chemical formation treatment, most of them becomes hexavalent molybdenum oxide.

With respect to the crystallized form of molybdenum oxide in a tungsten powder, molybdenum oxide may be crystals having the above-mentioned valence or may be amorphous. Amorphous is preferable from the viewpoint of conducting anodic oxidization uniformly. If molybdenum oxide is concentrated in one part of the particle surface region of a granulated powder and in the form of crystals of several tens of nanometers, a dielectric layer might not be uniformly formed, which is not desirable.

As the molybdenum element content in the tungsten powder of the present invention, 0.05 to 8 mass % is preferable and 0.2 to 5 mass % is particularly preferable. When the molybdenum element content is less than 0.05 mass %, the powder is not capable of imparting good left-to-stand LC characteristics to the electrolytic capacitors in some cases. When the molybdenum element content exceeds 8 mass %, it results in decrease in the capacitance of a capacitor and is not desirable.

In the present invention, a tungsten powder is granulated by putting a tungsten powder in a solution, in which a molybdenum compound is dissolved, and then filtering the resultant solution or sprinkling a tungsten powder with a solution of a molybdenum compound to thereby allow the solvent to be contained in the tungsten powder; and then sintering the tungsten powder under reduced pressure conditions. The solvent is to be decomposed or to evaporate at an appropriate temperature during the granulation, but it is possible to remove the solvent in advance in a vacuum dryer.

After sintering and cooling the powder to room temperature, the aggregated product taken out from the furnace is pulverized to obtain a granulated tungsten powder containing molybdenum oxide. After pulverizing the granulated powder, a fine powder or a powder of a large particle size may be classified to be removed. The removed powders can be sintered again singly or with other powders to be granulated.

The oxygen content in the particle surface region of the granulated powder can be appropriately adjusted by allowing a gas such as argon (Ar), in which an oxygen concentration is adjusted, to pass through the furnace when the granulated powder is taken out of the furnace.

The surface of the granulated Mo-containing tungsten powder of the present invention was shaved off by Ar-ion sputtering and the Mo-element distribution in a depth direction was analyzed by XPS (X-ray photoelectron spectroscopy). The analysis showed that Mo element exists in the region within 15 nm inside the particle from the particle surface of the granulated powder and most of the Mo element has a valence of six.

As the tungsten powder containing molybdenum element only in the first surface region of the present invention, a tungsten powder, which further contains at least one member selected from tungsten silicide, tungsten containing nitrogen solid solution, tungsten carbide and tungsten boride only in the particle surface region (second surface region), can be suitably used. Here, the size of the region varies depending on the treatment conditions for incorporating tungsten silicide, tungsten containing nitrogen solid solution, tungsten carbide and tungsten boride, but the region is generally to a depth of 50 nm inside the particle from the particle surface under ordinary treatment conditions. It is the same with the second surface region that the expression “contain XX element (or compound) only in the second surface region” does not require that 100% of the XX element (or compound) contained in the tungsten powder exists in the second surface region but means that 95% or more of the XX element (or compound) exists in the region.

The tungsten powder in which the second surface region is silicified can be obtained by, for example, mixing the silicon powder well into the tungsten powder and allowing the mixture to react by heating under reduced pressure. In the case of using this method, the silicon powder reacts with the tungsten from the surface of the tungsten particles and tungsten silicide such as W₅Si₃ is formed generally in the region within 50 nm inside the tungsten particle from the particle surface. The tungsten silicide content can be adjusted by the silicon amount to be added. In any kind of tungsten silicide, its content can be adjusted based on the silicon content. The silicon content of the tungsten powder of the present invention is preferably 0.05 to 7 mass %, and particularly preferably 0.2 to 4 mass %. The reduced-pressure condition is 10⁻¹ Pa or less, preferably 10⁻³ Pa or less. The reaction temperature is preferably 1,100 to 2,600 C.°. The heating time is preferably three minutes or more and two hours or less. The operation for adding silicon element can be conducted at the same time as the operation for adding molybdenum element.

As an example of the method for allowing a nitrogen solid solution to be contained only in the second surface region of various tungsten powders, there is a method of placing the tungsten powders at 350 to 1,500° C. under reduced pressure and allowing a nitrogen gas to pass through for from several minutes to several hours. A step of incorporating a nitrogen solid solution may be conducted at the time of producing a granulated powder and incorporating molybdenum element (at the time of sintering treatment under reduced pressure), or conducted prior to the step of incorporating molybdenum element. Further, the step of incorporating a nitrogen solid solution can be conducted at the time of producing a coarse powder, after the production of a granulated powder, or after the production of a sintered body. Thus, it is not specified when the step of incorporating a nitrogen solid solution is conducted during the production process of a tungsten powder, but it is preferable to allow the tungsten powder to have a nitrogen content of 0.01 to 1 mass % in an early stage of the production process. The treatment of incorporating a nitrogen solid solution can prevent excessive oxidation of the powder when the powder is handled in air.

As an example of the method of allowing carbon element to be incorporated in the second surface region of various tungsten powders, there is a method of placing the tungsten powders at 300 to 1,500° C. under reduced pressure in a high temperature vacuum furnace using carbon electrodes for from several minutes to several hours. The carbonization is conducted so as to adjust the carbon content to 0.001 to 0.5 mass % by selecting the temperature and period of time. The time when the carbonization is conducted during the production process is the same as the above-mentioned timing of incorporating a nitrogen solid solution. When the nitrogen gas is introduced into the furnace with carbon electrodes under predetermined conditions, carbonization and incorporation of a nitrogen solid solution can be conducted simultaneously, which enables the production of the tungsten powder containing molybdenum element in the first surface region and containing silicon, carbon and a nitrogen solid solution in the second surface region.

As an example of the method for allowing boron to be contained in the second surface region of the tungsten powder containing molybdenum element in the first surface region, there is a method of placing the boron element or a boron-containing compound as a boron source when granulating the tungsten powder. It is preferable to conduct the boronizing so that the boron content may be preferably 0.001 to 0.1 mass %. Good capacitance characteristics can be attained when the boron content is within the above-mentioned range. The time when the boronizing is conducted during the production process is the same as the above-mentioned timing of incorporating a nitrogen solid solution. When a powder subjected to the treatment of incorporating a nitrogen solid solution is put into a furnace having carbon electrodes, with a boron source placed in the furnace, and is granulated, it is possible to produce a tungsten powder containing molybdenum element in the first particle surface region and containing silicon, carbon, boron and a nitrogen solid solution in the second particle surface region. When the boronizing is conducted so as to incorporate boron in a predetermined amount (to have a boron content of preferably 0.001 to 0.1 mass %), the LC characteristics are further improved in some cases.

At least one member of a silicified tungsten powder, a tungsten powder containing a nitrogen solid solution, a carbonized tungsten powder, and a boronized tungsten powder may be added to a tungsten powder containing molybdenum element only in the first surface region. It is the same in this case that each element of molybdenum, silicon, nitrogen, carbon and boron is preferably blended in an amount so that each content in the mixed powder satisfies the above-mentioned range.

In the above-described methods of silicification, nitridation, carbonization and boronizing, each of tungsten powders containing molybdenum element in the first particle surface region was subjected to the treatment. It is also possible to subject a tungsten powder to at least one of silicification, carbonization, boronizing and incorporation of nitrogen solid solution in advance, and to incorporate molybdenum element in the first particle surface region of the resultant tungsten powder. It may be possible to subject a tungsten powder containing molybdenum element in the first particle surface region to at least one of silicification, carbonization, boronizing and incorporation of nitrogen solid solution; and to mix the resultant tungsten powder with a single pure tungsten powder. Again, each element of molybdenum, silicon, nitrogen, carbon and boron is preferably blended in an amount so that each content in the mixed powder satisfies the above-mentioned range.

The oxygen content in the whole tungsten powder of the present invention is preferably 0.05 to 8 mass %, more preferably 0.08 to 5 mass %.

One of methods for controlling the oxygen content to 0.05 to 8 mass % is to oxidize the second particle surface region of a tungsten powder, in which the second particle surface region is subjected to at least one of silicification, carbonization and boronizing. Specifically, nitrogen gas containing oxygen is introduced when the powder is taken out from a high temperature vacuum furnace at the time of producing a coarse powder or a granulated powder of each tungsten powder. When the temperature at the time of being taken out from the high temperature vacuum furnace is lower than 280° C., the oxidization takes priority over the incorporation of nitrogen solid solution. By adjusting the partial pressure of oxygen in the mixed gas of oxygen and nitrogen and the mixed gas pressure in the furnace, a predetermined oxygen element content can be obtained. By making each of the tungsten powders have a predetermined oxygen content in advance, it is possible to reduce the deterioration due to the excessive oxidation due to the formation of a natural oxide film having an uneven thickness during the subsequent processes for producing anode bodies for electrolytic capacitors using the powder. In cases where the oxygen content is within the above-mentioned range, the LC characteristics of the produced electrolytic capacitors can be kept better. In the case when nitrogen solid solution is not introduced in this process, an inert gas such as argon and helium may be used instead of the nitrogen gas.

The phosphorus element content in the tungsten powder of the present invention is preferably from 1 to 500 ppm by mass.

As an example of the methods for incorporating the phosphorus element in an amount of from 1 to 500 ppm in the tungsten powder containing molybdenum in the first particle surface region, in which tungsten powder at least one of silicification, carbonization, boronizing, oxidation and incorporation of a nitrogen solid solution is conducted on the second particle surface region, there is a method of producing a powder containing phosphorus by placing phosphorus or a phosphorus compound as a phosphorus source in a high temperature vacuum furnace at the time of producing a coarse powder or a granulated powder of each tungsten powder. It is also possible to incorporate molybdenum element and phosphorus element at the same time by using phosphomolibdic acid as a molybdenum solution at the time of incorporating molybdenum element in the surface layer of a tungsten powder.

It is preferable to incorporate phosphorus in the tungsten powder so as to make the phosphorus content within the above-mentioned range by controlling the amount of the phosphorus source and the like because the physical breakdown strength of the anode bodies produced thereof can be improved in some cases. When the phosphorus content falls within the range, LC characteristics of the manufactured electrolytic capacitor are further improved.

To attain better capacitance characteristics in the tungsten powder containing molybdenum in the first particle surface region, it is preferable to keep the total content of impurity elements other than each element of molybdenum, silicon, nitrogen, carbon, boron, oxygen and phosphorus in the powder to 0.1 mass % or less. In order to keep the content of these elements to the above-mentioned value or lower, the amount of the impurity elements contained in the raw materials, a pulverizing member to be used, containers and the like should be kept low.

An anode body for a capacitor can be obtained by sintering the tungsten powder of the present invention. Further, by giving a structure comprising a composite of an anode and a dielectric layer obtained by anodizing the anode body, and a cathode formed on the dielectric layer, an electrolytic capacitor is fabricated.

### EXAMPLES

The present invention is described below by referring to Examples and Comparative Examples, but the present invention is not limited thereto.

In the present invention, the measurement of the particle diameter and elemental analysis were carried out by the methods described below.

The volume-average particle diameter was measured by using HRA9320-X100 manufactured by Microtrac Inc. and the particle size distribution was measured by the laser diffraction scattering method. A particle size value (D₅₀; μm) when the accumulated volume % corresponded to 50 volume % was designated as the average particle size. The diameter of the secondary particles is to be measured by this method. However, since a coarse powder generally has good dispersibility, the average particle diameter of the coarse powder measured by the above measuring equipment can be regarded as substantially the same as an average primary particle diameter.

For the elemental analysis, ICP emission spectrometry was performed by using ICPS-8000E manufactured by Shimadzu Corporation.

### Example 1

A tungsten powder having a volume-average particle diameter of 0.4 μm obtained by reducing commercially-available tungsten trioxide with hydrogen was put in an aqueous solution of 0.16 mass % ammonium molybdate and mixed well. After washing the powder with water and then with ethanol, the powder was put in a vacuum dryer and dried by removing ethanol at 60° C. Next, the powder was heated under the vacuum condition of 5×10⁻³ Pa at 1,400° C. for 20 minutes to be reacted. The obtained granulated powder was subjected to elemental analysis and the powder contained 0.055 mass % of molybdenum element and each of other impurity elements in an amount of 350 ppm by mass or less.

### Examples 2 to 3 and Comparative Examples 1 to 3

A granulated tungsten powder was obtained in the same way as in Example 1 except that the concentration of the aqueous solution of ammonium molybdate was changed as shown in Table 1. The molybdenum content in the granulated powder obtained in each of examples is shown in Table 1 and the content of each of other impurity elements was 350 ppm by mass or less.

The granulated powder produced in each of the above-described examples was formed to produce a formed body having a size of 1.8×3.0×3.5 mm. A tantalum wire having a diameter of 0.29 mm is vertically implanted in the 1.8×3.0 mm face, 2.8 mm of which is inserted inside and 8 mm of which protrudes outside the sintered body. The formed body was sintered in a high-temperature vacuum furnace at 1,400° C. for 30 minutes to thereby obtain a sintered body of 145 mg by mass.

The obtained sintered body was used as an anode body for an electrolytic capacitor. The anode body was subjected to chemical formation in an aqueous solution of 0.1 mass % phosphoric acid at 9 V for two hours to thereby form a dielectric layer on the surface of the anode body. The anode body having a dielectric layer formed thereon was immersed in an aqueous solution of 30% of sulfuric acid to form an electrolytic capacitor using platinum black as a cathode. The capacitance and LC (leakage current) of the capacitor were measured. The capacitance was measured by using an LCR meter manufactured by Agilent at room temperature, 120 Hz and bias voltage of 2.5 V. The LC value 30 seconds after applying a voltage of 2.5 V at room temperature (initial LC value) and the LC value after seven days (left-to-stand LC value) were measured.

The results of each of Examples and Comparative Examples are shown in Table 1. The capacitance and LC values are an average of 128 pieces in each of examples.

TABLE 1

| | | | Content of | | | |
|---|---|---|---|---|---|---|
| | Molybdenum- | Concentration | molybdenum | Initial | Initial | LC after |
| | containing | of solution | element | capacitance | LC | standing |
| | compound | (mass %) | (mass %) | (μF) | (μA) | (μA) |
| Example 1 | Ammonium | 0.16 | 0.055 | 343 | 68 | 66 |
| | molybdate | | | | | |
| Example 2 | Same as above | 2 | 0.70 | 331 | 65 | 65 |
| Example 3 | Same as above | 22 | 7.95 | 287 | 67 | 68 |
| Comparative | Same as above | 0 | 0.009 | 342 | 65 | 145 |
| Example 1 | | | | | | |
| Comparative | Same as above | 0.13 | 0.048 | 338 | 63 | 156 |
| Example 2 | | | | | | |
| Comparative | Same as above | 25 | 8.73 | 265 | 65 | 140 |
| Example 3 | | | | | | |

It can be seen from the results shown in Table 1 that good left-to-stand LC characteristics are attained in the cases where the molybdenum element content is 0.05 to 8 mass % (Examples 1 to 3). In contrast, it can be seen that the powder deteriorates in the left-to-stand characteristics in the case where the molybdenum element content is less than 0.05 mass % (Comparative Examples 1 to 2). In the case where the molybdenum element content exceeds 8 mass %, the capacitance decreases and degradation of the left-to-stand LC characteristics is caused (Comparative Example 3).

### Example 4

200 g of commercially-available tungsten powder having an average diameter of 0.5 μm (ungranulated powder) was put in 400 g of water, in which 10 mass % of ammonium persulfate was dissolved, and stirred well with a homogenizer to oxidize the tungsten surface layer. After washing with water, 500 ml of an aqueous solution of 2N sodium hydroxide was added thereto and stirred to remove the oxide on the surface layer. The series of operations of oxidization and removal of the oxide was repeated three times. After putting the obtained tungsten powder having a volume-average diameter of 0.2 μm in an ethanol solution of 0.15 mass % ammonium phosphomolybdate and mixing well, the mixture was placed in a vacuum dryer and dried by removing ethanol at 60° C. Next, the powder was sintered under the vacuum condition of 5×10⁻³ Pa at 1,370° C. for 20 minutes to be reacted. The obtained granulated powder was subjected to elemental analysis and the powder contained 0.058 mass % of molybdenum element, 52 ppm of phosphorus, and each of other impurity elements in an amount of 350 ppm by mass or less.

### Examples 5 to 6 and Comparative Examples 4 to 5

A granulated tungsten powder was obtained in the same way as in Example 4 except that the concentration of the aqueous solution of ammonium phosphomolybdate was changed as shown in Table 2. The molybdenum content and the phosphorus content in the granulated powder obtained in each of examples are shown in Table 2 and the content of each of other impurity elements was 350 ppm by mass or less.

A formed body was produced in the same way as in Examples 1 to 3 and Comparative Examples 1 to 3 by forming the granulated powder produced in Examples 4 to 6 and Comparative Examples 1 to 3. By sintering the formed body in a high-temperature vacuum furnace in a similar manner to Examples 1 to 3 and Comparative Examples 4 to 6, a sintered body of 145 mg by mass was obtained.

The obtained sintered body was used as an anode body for an electrolytic capacitor. The anode body was subjected to chemical formation in an aqueous solution of 0.1 mass phosphoric acid at 9 V for two hours to thereby form a dielectric layer on the surface of the anode body. The anode body having a dielectric layer formed thereon was immersed in an aqueous solution of 30% of sulfuric acid to form an electrolytic capacitor using platinum black as a cathode. The capacitance and LC (leakage current) of the capacitor were measured. The capacitance was measured by using an LCR meter manufactured by Agilent at room temperature, 120 Hz and bias voltage of 2.5 V. The LC value 30 seconds after applying a voltage of 2.5 V at room temperature (initial LC value) and the LC value after seven days (left-to-stand LC value) were measured. The results are shown in Table 2. The capacitance and LC values are an average of 128 pieces in each of examples.

TABLE 2

| | | | Content of | Content of | | | |
|---|---|---|---|---|---|---|---|
| | Molybdenum- | Concentration | molybdenum | phosphorus | Initial | Initial | LC after |
| | containing | of solution | element | element | capacitance | LC | standing |
| | compound | (mass %) | (mass %) | (mass %) | (μF) | (μA) | (μA) |
| Example 4 | Ammonium | 0.15 | 0.058 | 52 | 940 | 76 | 80 |
| | phospho- | | | | | | |
| | molybdate | | | | | | |
| Example 5 | Same as above | 2 | 0.83 | 72 | 922 | 78 | 81 |
| Example 6 | Same as above | 18 | 7.84 | 469 | 897 | 75 | 79 |
| Comparative | Same as above | 0.12 | 0.046 | 0.43 | 946 | 77 | 161 |
| Example 4 | | | | | | | |
| Comparative | Same as above | 20 | 8.66 | 571 | 874 | 72 | 188 |
| Example 5 | | | | | | | |

It can be seen from the results shown in Table 2 that good left-to-stand LC characteristics are attained in the cases where the molybdenum element content is 0.05 to 8 mass % and the phosphorus element content is 1 to 500 ppm by mass (Examples 4 to 6). In contrast, it can be seen that the powder deteriorates in the left-to-stand characteristics in the case where the molybdenum element content is less than 0.05 mass % and the phosphorus element content is less than 1 ppm by mass (Comparative Example 4). In the case where the molybdenum element content exceeds 8 mass % and the phosphorus element exceeds 500 ppm by mass, degradation of the left-to-stand LC characteristics is caused (Comparative Example 5).

1. A tungsten powder, comprising molybdenum element only in the particle surface region (first surface region) and having a molybdenum element content of 0.05 to 8 mass %.

2. The tungsten powder as claimed in claim 1, wherein the molybdenum element exists as being molybdenum oxide.

3. The tungsten powder as claimed in claim 2, wherein the valence of the molybdenum atom in the molybdenum oxide is six.

4. The tungsten powder as claimed in claim 1, wherein the volume average diameter of the primary particle is 0.1 to 1 μm.

5. The tungsten powder as claimed in claim 1, wherein the first surface region is a region from the particle surface to a depth of 20 nm inside the particle.

6. The tungsten powder as claimed in claim 1, further comprising at least one member selected from tungsten containing nitrogen solid solution, tungsten silicide, tungsten carbide, and tungsten boride only in the particle surface region (second surface region).

7. The tungsten powder as claimed in claim 1, wherein the phosphorus content is 1 to 500 ppm by mass.

8. The tungsten powder as claimed in claim 1, wherein the content of elements other than each element of tungsten, molybdenum, silicon, nitrogen, carbon, boron, phosphorus and oxygen is 0.1 mass % or less.

9. The tungsten powder as claimed in claim 6, wherein the second surface region is a region from the particle surface to a depth of 50 nm inside the particle.

10. The tungsten powder as claimed in claim 1, wherein the tungsten powder is a granulated powder.

11. An anode body for a capacitor obtained by sintering the tungsten powder claimed in claim 1 above.

12. An electrolytic capacitor, which is provided with a complex of an anode and a dielectric layer obtained by anode oxidation of the anode body claimed in claim 11, and a cathode formed on the dielectric layer.

13. A method for producing the tungsten powder claimed in claim 1 by mixing a tungsten powder with an aqueous solution of a molybdenum compound so that the molybdenum element content in the tungsten powder falls within a range of 0.05 to 8 mass %, and by allowing the mixture to react through heating under reduced pressure.

14. The method for producing the tungsten powder as claimed in claim 13, wherein the heating temperature is from 1,000 to 2,600° C.

15. The method for producing the anode body for a capacitor, comprising sintering the tungsten powder claimed in claim 1.
